(19) United States
(12) Patent Application Publication
(10) Pub. No.: US 2007/0241852 A1
(43) Pub. Date: Oct. 18, 2007

(54) Transformer with foamed insulating material and method of manufacturing the same

(76) Inventor: Joel S. Goudreau, Winterville, NC (US)

Correspondence Address: ABB Inc.;Legal Dept. -4U6, 29801 Euclid Avenue, Wickliffe, OH, 44092-1832, US

(21) Appl. No.: 11/404,182

(22) Filed: Apr. 14, 2006

(51) Int. Cl. H01F 5/00

(52) U.S. Cl. 336/200; 29/602.1; 336/212

(57) ABSTRACT

The invention is directed to a transformer and a method of manufacturing the same, wherein a core and coil assembly and a housing with an injection opening are provided. The core and coil assembly are enclosed in the housing. A polyurethane foam insulating material is injected into the housing through the injection opening using a dispensing gun.

### BACKGROUND OF THE INVENTION

This invention relates to transformers and more particularly to transformers having a dry-type construction with solid insulation.

A transformer with a dry-type construction has a core/coil assembly encapsulated in a solid insulating material to insulate and seal the core/coil assembly from the outside environment. One type of transformer that typically has a dry-type construction is an instrument transformer. Instrument transformers are used in measurement and protective applications, together with equipment, such as meters and relays. An instrument transformer “steps down” the current or voltage of a system to a standardized value that can be handled by associated equipment. For example, a current instrument transformer may step down current in a range of 10 to 2,500 amps to a current in a range of 1 to 5 amps, while a voltage instrument transformer may step down voltage in a range of 12,000 to 40,000 volts to a voltage in a range of 100 to 120 volts.

Conventional insulating materials that have been used in dry-type transformers include butyl rubber, cycloaliphatic epoxy, polyurethane rubber, and more recently, hydrophobic cycloaliphatic epoxy. Of these materials, polyurethane rubber is the easiest to work with. Polyurethane rubber is a segment polymer comprising soft segments (polyethers, polyesters) of relatively high molecular weight (for example 1,000 to 4,000) and hard segments (polyurethane or polyurea). Uncured polyurethane rubber is formed by reacting a hydroxyl-terminated polyester or polyether with an excess of a diisocyanate to form an NCO-terminated prepolymer which is subsequently reacted with a short-chain diol or diamine for chain extension. The uncured polyurethane rubber is then cured into polyurethane rubber using a crosslinking agent, such as a diisocyanate, a peroxide or sulfur.

Encapsulation of a core/coil assembly with any of the foregoing insulating materials, including polyurethane rubber, requires the core/coil assembly to first be placed in a suitable mold. The insulating material is then poured into the mold to fill all the cavities therein before being cured to a solid state. Although such insulating materials provide satisfactory results, the encapsulating process is time consuming since it normally requires several hours to cure the encapsulating materials, such as butyl rubber or epoxy resin, to a solid state.

In order to reduce the time required to encapsulate a core/coil assembly, it has been proposed to use an injection molding process to inject insulating material into a mold containing a core/coil assembly. An example of a core/coil assembly that is encapsulated using an injection molding process is disclosed in U.S. Pat. No. 4,199,743. In the '743 patent, the insulating material is a thermoplastic blend of a partially cured monoolefin copolymer rubber and a polyolefin. Although injection molding reduces the time of the encapsulation process, injection molding requires high temperatures and pressures, which may not be suitable for many transformer applications.

It would therefore be desirable, to provide a dry-type transformer having an insulating material that can be applied and cured in a short amount of time. The present invention is directed to such a transformer and a method for manufacturing such a transformer.

### SUMMARY OF THE INVENTION

In accordance with the present invention, a method of manufacturing a transformer is provided. In accordance with the method, a core and coil assembly and a housing with an injection opening are provided. The core and coil assembly are enclosed in the housing and a foam insulating material is injected into the housing through the injection opening.

Also provided in accordance with the present invention is a transformer that has a core and coil assembly enclosed within a housing. A foam insulating material is disposed in the housing around at least a portion of the core and coil assembly. The foam insulating material has a density in a range from about 2.0 to about 3.0 pounds/ft³ and a compression strength of from about 20 to about 30 psi and is a polyurethane foam formed from first and second components. The first component comprises water and one or more polyols and the second component comprises one or more polyisocyanates.

### BRIEF DESCRIPTION OF THE DRAWINGS

The features, aspects, and advantages of the present invention will become better understood with regard to the following description, appended claims, and accompanying drawings where:

FIG. 1 is a front perspective view of a transformer manufactured in accordance with the present invention;

FIG. 2 is a plan view of a first shell of a housing of the transformer;

FIG. 3 is a plan view of a second shell of the housing of the transformer;

FIG. 4 is a perspective view of a dispensing system being used to fill the transformer with a foam insulating material; and

FIG. 5 is a schematic sectional view of a second transformer manufactured in accordance with the present invention.

### DETAILED DESCRIPTION OF ILLUSTRATIVE EMBODIMENTS

It should be noted that in the detailed description that follows, identical components have the same reference numerals, regardless of whether they are shown in different embodiments of the present invention. It should also be noted that in order to clearly and concisely disclose the present invention, the drawings may not necessarily be to scale and certain features of the invention may be shown in somewhat schematic form.

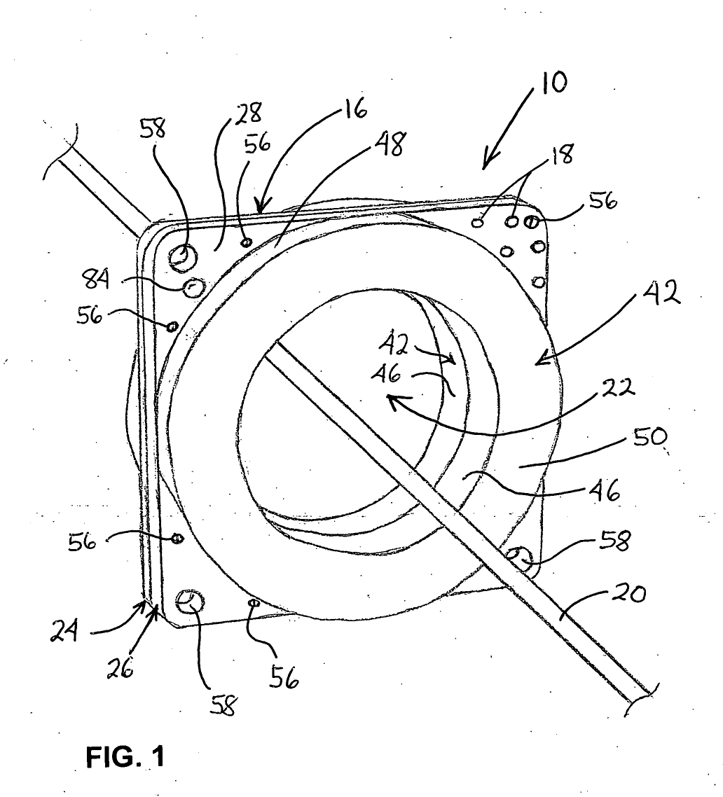

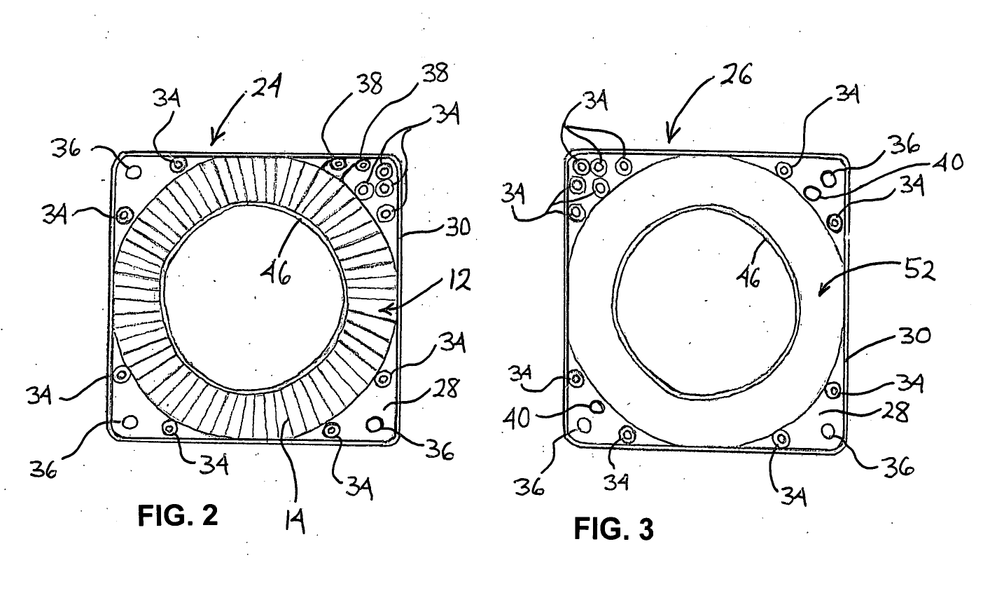

Referring now to FIGS. 1 and 2, there are shown views of a transformer 10 that can be provided with an insulating material in accordance with the present invention. The transformer 10 is a window-type or donut-type current transformer that generally comprises a core 12, a secondary winding 14 and an outer housing 16. The core 12 has a torroidal shape and is composed of a ferromagnetic material, such as iron or steel. The core 12 has a diameter of between about seven inches and about thirteen inches. The core 12 may be comprised of a stack of annular plates of grain-oriented silicon steel. The secondary winding 14 comprises a length of wire, such as copper wire, wrapped around the core 12 to form a plurality of turns that are disposed around the circumference of the core 12. End portions of the secondary winding 14 are not wound on the core 12 so that they may be connected to terminal screws 18 accessible from the exterior of the housing 16, as will be describe below. A conductor 20 passes through an enlarged opening 22 in the transformer 10 and constitutes a primary winding. In other applications, a bus bar, bushing, or a breaker bus-side stab may extend through the opening 22 in lieu of the conductor 20.

The housing 16 has a two-piece construction and comprises first and second shells 24, 26, each of which is composed of a high impact plastic, such as polycarbonate or high density polyethylene. Each of the first and second shells 24, 26 includes a square mounting plate 28 with a peripheral flange 30 and an enlarged central opening. A plurality of mounting bosses 34 are joined to the mounting plate and have bores extending through the mounting plate 28. The mounting bosses 34 are disposed around the periphery of the mounting plate 28 and are disposed proximate to the peripheral flange 30. In three corners of the mounting plate 28, tubular sleeves 36 are joined to the mounting plate 28 and have passages extending through the mounting plate 28. Toward a fourth corner of the mounting plate in the first shell 24, a pair of terminal mounts 38 are secured to the mounting plate 28 and extend outwardly therefrom. Each of the terminal mounts 38 has a threaded passage for receiving a terminal screw 18. End portions of the secondary winding 14 are connected to the terminal mounts 38 in the first shell 24. In the second shell 26, a pair of injection openings 40 are formed in the mounting plate 28, toward opposing corners. Each of the injection openings 40 has a diameter of about 0.625 of an inch. In each of the first and second shells 24, 26, a cylindrical mount 42 is integrally joined to the mounting plate 28 around the central opening. The cylindrical mount 42 has cylindrical radially inner and outer walls 46, 48 joined at an outer end wall 50 that cooperate to define an interior annular groove 52 for receiving a portion of the core 12 with the secondary winding 14 wound thereon.

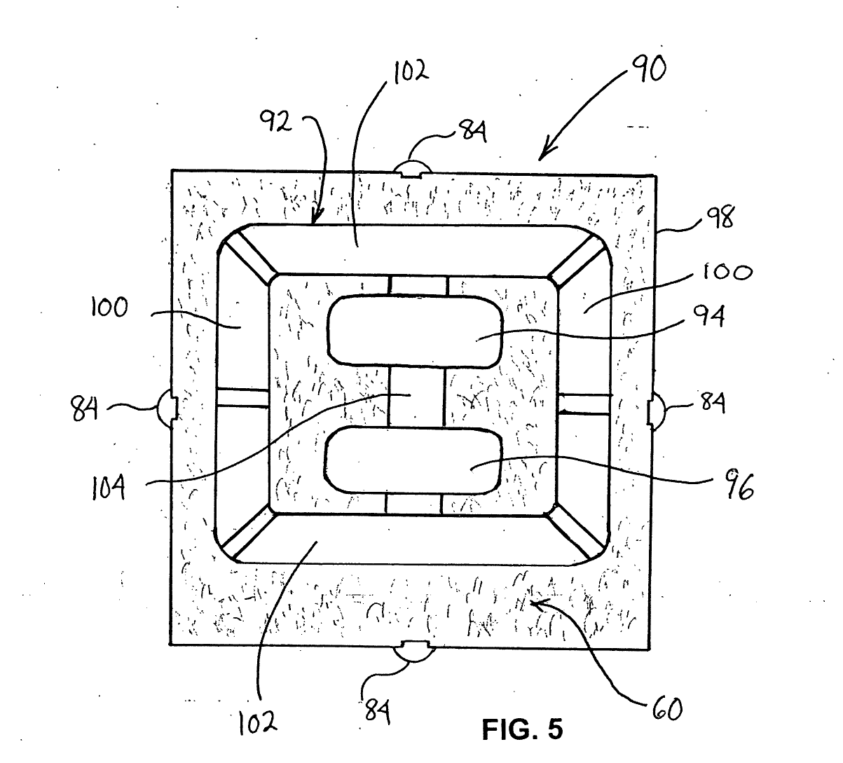

The transformer 10 is produced by inserting the core 12 with the secondary winding 14 wound thereon into the annular groove 52 of the first shell 24 and then connecting the end portions of the secondary winding 14 to the terminal mounts 38, respectively. The second shell 26 is then aligned with, and disposed over, the first shell 24 so that the core 12 with the secondary winding 14 is also disposed in the annular groove 52 of the second shell 26 and the mounting bosses 34 on the first and second shells 24, 26 are aligned. Self tapping screws 56 are then secured in the bores of the aligned mounting bosses 34, thereby securing together the first and second shells 24, 26 with the core 12 and the secondary winding 14 mounted in between. With the first and second shells 24, 26 secured together in the foregoing manner, the radially inner wall 46, the peripheral flange 30 and the sleeves 36 of the first shell 24 abuts the radially inner wall 46, the peripheral flange 30 and the sleeves 36 of the second shell 26, respectively, to close the housing 16 from the exterior. The abutment of the sleeves 36 forms three mounting passages 58 that extend through the transformer 10 and may be used to mount the transformer 10 to a structure. The terminal mounts 38 in the first shell 24 are aligned with, and abut, mounting bosses 34 in the second shell 26. The terminal screws 18 are inserted through the mounting bosses 34 and are threadably received in the terminal mounts 38. Inside the housing 16, gaps or voids are formed between the first and second shells 24, 26, primarily at the four corner regions of the abutting mounting plates 28. Once the core 12 and secondary winding are secured within the housing 16, a foam insulating material 60 (shown in FIG. 5) is injected into the housing 16 through the injection openings 40 to fill the voids, as will be described in more detail below.

The foam insulating material 60 is a rigid polyurethane foam formed from the combination of a first compound and a second compound. The foam insulating material has an overall density (per ASTM D-1622) in a range from about 0.5 to about 5 pounds/ft³ and a compression strength (per ASTM D-1621) of from about 5 to about 30 psi. More particularly, the foam insulating material has an overall density (per ASTM D-1622) in a range from about 2.0 to about 3.0 pounds/ft³ and a compression strength (per ASTM D-1621) of from about 20 to about 30 psi.

The first compound comprises one or more polyols, water, one or more catalysts and other additives. The polyols may be polyester polyols, polyether polyols, or a combination of polyester and polyether polyols. Suitable polyester polyols include reaction products of a polyol such as a diol, with a polycarboxylic acid, such as a dicarboxylic acid, or its anhydride, such as a dicarboxylic acid anhydride. Suitable polyether polyols include reaction products of an alkylene oxide (such as ethylene oxide, propylene oxide, or butylene oxide) and an active hydrogen-containing compound (initiator), such as glycerin, trimethylolpropane, pentaerythritol, sucrose, sorbitol, water, bisphenol A, ethylenediamine, toluenediamine, ethylene glycol, and propylene glycol. In one embodiment, the first compound comprises a blend of two or more low molecular weight polyether polyols (i.e., each polyether polyol has a molecular weight of less than 2000 g/mol). In order to provide more flexibility and elasticity to the foam insulating material, one or more medium molecular weight polyether polyols (having a molecular weight of from about 2000 g/mol to about 4000 g/mol) may also be included with the low molecular weight polyether polyols.

The water in the first compound is provided in an amount sufficient to act as a blowing agent, wherein the water reacts with isocyanate groups in the second compound to generate CO₂, which expands the resulting polyurethane to produce foam. Water is present in an amount ranging from about 2 to about 8 percent by weight, based on the total weight of the first compound.

The one or more catalysts facilitate the reaction of the first and second compounds. Suitable catalysts include amine compounds, such as dimethylethanolamine, triethylenediamine, dimethylcyclohexylamine, 1,2-dimethylimidazole, pentamethyldiethylenetriamine, bis(2-dimethylaminoethyl)ether, pentamethyidiethylenetriamine, and bis(2-dimethylaminoethyl)ether. Other catalysts that may be used include alkali metal alkoxides or carboxylates. The one or more catalysts comprise from about 0.01 to about 3 percent by weight of the first compound.

The other additives may include one or more flame retardants, surfactants, cell-opening agents, and fillers. Suitable flame retardants include halogen-based, phosphorous-based and nitrogen-based flame retardant compositions. These compositions include brominated diphenyl oxides, chlorinated phosphate esters, triaryl phosphate esters, sodium antimonates and other suitable flame retardant compositions. Specific examples of suitable flame retardants include tri(2-chloroisopropyl)phosphate, diethyl-N,N-bis(2-hydroxy ethyl)aminomethyl phosphate, tetrabromophthalate diol, triethyl phosphonate, pentabromodiphenyl oxide, and tri(2,2-dichloroisopropyl)phosphate. The one or more flame retardants comprise from about 10 to about 40 percent by weight of the first compound.

The second compound comprises at least one polyisocyanate having two or more aliphatic and/or aromatic isocyanate groups. Suitable aliphatic polyisocyanates include hexamethylenediisocyanate (HDI) and isophorone diisocyanate (IPDI). Suitable aromatic isocyanates include toluene diisocyanate (TDI), diphenylmethane diisocyanate (MDI), and mixtures of diphenylmethane diisocyanate and polyphenylpolymethylene polyisocyanates (polymeric MDI). In one embodiment, the second compound comprises a mixture of MDI and polymeric MDI and has an average isocyanate functionality ranging from about 2.0 to about 3.5. The MDI constituent more specifically is a mixture of 2,4′- and 4,4′-isomers, with the 4,4′-isomer comprising greater than 50 weight percent of such mixture, based on the total weight of the mixture. The polymeric MDI constituent may be present in the second compound in an amount ranging from about 30 to about 70 percent by weight of the second compound.

An example of a commercially available product that may be used for the first and second compounds is Instapak® Rigid 150, which is a two-part product (Component “A” and Component “B”) available from the Sealed Air Company of Saddlebrook N.J.

The first and second compounds are stored in separate containers, such as first and second drums 64, 66, respectively. A dispensing system 70 is connected to the first and second drums 64, 66 and mixes together the first and second compounds and dispenses the resulting mixture into the transformer 10. The first and second compounds are mixed together in proportions such that from about 0.8 (more particularly about 0.95) to about 1.5 (more particularly about 1.15) isocyanate groups in the second compound are provided per active hydroxyl group in the first group.

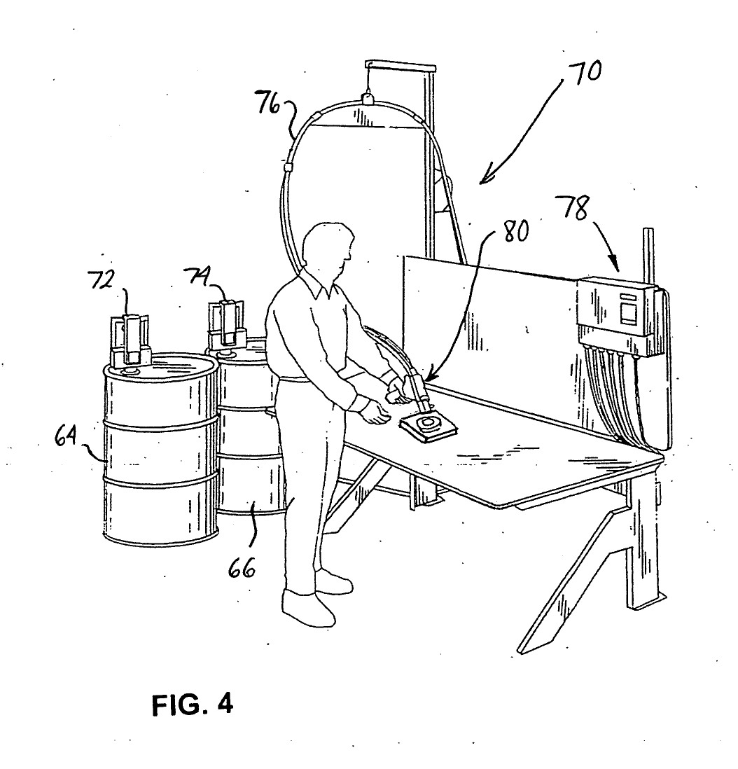

Referring now to FIG. 4, the dispensing system 70 generally includes electric first and second pumps 72, 74, hoses 76, electrical resistance heaters (not shown), a main controller 78, and a dispensing gun 80. The first and second pumps 72, 74 are mounted to the first and second drums 64, 66, respectively, and are operable to pump the first and second compounds through the hoses 76 (which are bundled) to the dispensing gun 80. The first and second pumps 72, 74 are controlled by local controllers and the main controller 78 to discharge the first and second compounds at predetermined rates of flow. The flow rates of the first and second compounds are selected to be in the same ratio as the desired ratio of the first and second compounds when they are mixed and reacted to form the foam insulating material 60. In one embodiment, the ratio of the mass flow rate of the second compound to the mass flow rate of the first compound is between about 1.1 to about 1.4. The heaters are also controlled by the main controller 78 and are operable to respectively heat the first and second compounds to a temperature of about 145° F. as they are being pumped to the dispensing gun 80. The heaters may be built into the hoses 76, disposed around the hoses 76, or interconnected with the hoses 76. The dispensing gun 80 includes a housing enclosing a valve cartridge connected to drive means. The hoses 76 are connected to supply passages in the dispensing gun 80, respectively. The valve cartridge includes a mixing chamber with inlets connected to the supply passages. The inlets are opened and closed by a valve rod that is moved by the drive means. The drive means is actuated by a manually-actuatable trigger and may be an electric motor or pressurized air. In the embodiment where the drive means is an electric motor, the dispensing gun 80 may be controlled by the main controller 78 to dispense a mixture of the first and second compounds for a selected period of time. An example of a dispensing gun with an electric motor is disclosed in U.S. Pat. No. 5,590,816, which is hereby incorporated by reference, and an example of a dispensing gun with pneumatic drive means is disclosed in U.S. Pat. No. 4,568,003, which is also hereby incorporated by reference.

An example of a commercially available electric dispensing system that may be used for the dispensing system 70 is the Instapak® 901 system available from the Sealed Air Company of Saddlebrook N.J.

Instead of using an electric dispensing system (such as the dispensing system 70), the method of the present system may use a pneumatic dispensing system wherein a source of pressurized non-reactive gas (such as air or CO₂) is supplied through a dispensing gun to the first and second drums 64, 66 and pneumatic pumps (such as bladder pumps) disposed therein. The non-reactive gas is directed to the pneumatic pumps and into contact with the first and second compounds. The non-reactive gas causes the pneumatic pumps to pressurize the first and second compounds and to pump the first and second compounds (with the non-reactive gas dissolved therein) out of the first and second drums 64, 66 and into the dispensing gun where they are mixed together and then ejected. An example of such a pneumatic system is disclosed in U.S. Pat. No. 5,055,272, which is hereby incorporated by reference.

The voids in the housing 16 are filled with the foam insulating material 60 using the dispensing system 70. An operator places a nozzle of the dispensing gun 80 against the housing 16 of the transformer 10 around a first injection opening 40 such that an outlet orifice of the nozzle is aligned with the first injection opening 40. The operator then actuates the trigger of the dispensing gun 80, which causes the first and second compounds to enter the mixing chamber of the dispensing gun and become mixed. The resulting foam insulating material 60 exits the dispensing gun through the outlet orifice of the dispensing gun 80 at a mass flow rate in a range of about 6 to about 7 pounds per minute and enters the housing 16 through the first injection opening 40. Inside the housing 16, the foam insulating material 60 expands and fills a portion of the voids. After a predetermined amount of time, such as from about one to about two seconds, the main controller 78 causes the dispensing gun 80 to stop dispensing the foam insulating material 60. The operator than places the nozzle of the dispensing gun 80 over the second injection opening 40 and the procedure is repeated to inject more foam insulating material 60 into the housing 16 to fill the remaining portion of the voids. After the foam insulating material 60 is injected into the housing 16 through the second injection opening 40, plastic dome plugs 84 with resilient aperture engaging fingers are pressed into the injection openings 40 to securely close the same. In this manner, the voids in the housing 16 are filled with the foam insulating material 60, which, as set forth above is a rigid polyurethane foam.

It should be appreciated that instead of using a dispensing system with the manually-actuatable dispensing gun 80, a dispensing system with an automated dispensing gun may utilized. Such an automated dispensing gun may be a part of a fully automated system in which transformers are assembled by robotic devices and are moved on a conveyor to and from the automated dispensing gun.

Referring now to FIG. 5, there is shown a transformer 90 manufactured in accordance with the present invention. The transformer 90 includes a core 92, primary and secondary windings 94, 96, and an outer housing 98. The transformer 90 is a voltage instrument transformer. The core 92 is comprised of ferromagnetic metal and is generally rectangular in shape. The core 92 includes a pair of outer legs 100 extending between a pair of yokes 102. An inner leg 104 also extends between the yokes 102 and is disposed between and substantially evenly spaced from the outer legs 100. The primary and secondary windings 94, 96 are disposed around the inner leg 104. The housing 98 encloses the core 92 and the primary and secondary windings 94, 96 and includes a plurality of injection openings closed by dome plugs 84. The foam insulating material 60 is disposed inside the housing 98, around and inside the core 92 and around the primary and secondary windings 94, 96. The foam insulating material 60 has been injected into the housing 98 through the injection openings using the dispensing system 70 in substantially the same manner as in the transformer 10.

Although the present invention has been described with regard to instrument transformers 10, 90, it should be appreciated that the present invention may be used with other types of dry-type transformers as well.

It is to be understood that the description of the foregoing exemplary embodiment(s) is (are) intended to be only illustrative, rather than exhaustive, of the present invention. Those of ordinary skill will be able to make certain additions, deletions, and/or modifications to the embodiment(s) of the disclosed subject matter without departing from the spirit of the invention or its scope, as defined by the appended claims.

What is claimed is:

1. A method of manufacturing a transformer comprising:
providing a core and coil assembly;
providing a housing with an injection opening;
enclosing the core and coil assembly in the housing; and
injecting a foam insulating material into the housing through the injection opening.

2. The method of claim 1, wherein the foam insulating material has a density in a range from about 0.5 to about 5 pounds/ft³ and a compression strength of from about 5 to about 30 psi.

3. The method of claim 1, further comprising:
providing a first component and a second component; and
mixing the first component and the second component to form the foam insulating material.

4. The method of claim 3, further comprising heating the first and second components before mixing the first and second components.

5. The method of claim 3, wherein the first component comprises one or more polyols and the second component comprises one or more polyisocyanates, and the foam insulating material is a polyurethane foam.

6. The method of claim 3, wherein the first component further comprises water and wherein the one or more polyols comprises two or more polyether polyols, and wherein the second component comprises diphenylmethane diisocyanate and polyphenylpolymethylene polyisocyanate.

7. The method of claim 3, wherein the step of injecting the foam insulating material into the housing is performed with a dispensing gun.

8. The method of claim 7, wherein the step of mixing the first and second components is performed in the dispensing gun.

9. The method of claim 1, wherein the step of injecting the foam insulating material into the housing is performed with a dispensing gun.

10. The method of claim 9, wherein the dispensing gun is manually actuatable.

11. The method of claim 1, wherein the transformer is a current transformer and the core and coil assembly comprises a secondary winding wound around a torroidal core.

12. The method of claim 10, wherein the housing has an enlarged opening through which a conductor may be disposed, said conductor acting as a primary winding.

13. The method of claim 1, wherein the step of injecting the foam insulating material into the housing is performed for a predetermined amount of time.

14. The method of claim 1, wherein the housing comprises first and second sections, and wherein the step of enclosing the core and coil assembly comprises:
placing the core and coil assembly in the first section;
placing the second section over the first section to enclose the core and coil assembly; and
securing the first and second sections together.

15. The method of claim 1, further comprising closing the injection opening with a plug after the step of injecting the foam insulating material.

16. A transformer manufactured in accordance with the method of claim 1.

17. A transformer comprising:
a housing;
a core and coil assembly enclosed within the housing; and
a foam insulating material disposed in the housing around at least a portion of the core and coil assembly, the foam insulating material having a density in a range from about 2.0 to about 3.0 pounds/ft³ and a compression strength of from about 20 to about 30 psi and being a polyurethane foam formed from first and second components, the first component comprising water and one or more polyols and the second component comprising one or more polyisocyanates.

18. The transformer of claim 17, wherein the one or more polyols comprises two or more polyether polyols, and wherein the second component comprises diphenylmethane diisocyanate and polyphenylpolymethylene polyisocyanate.

19. The transformer of claim 17, wherein the housing has an injection opening closed by a plug.

20. The transformer of claim 17, wherein the transformer is a current transformer and the core and coil assembly comprises a secondary winding wound around a torroidal core.
